(19) United States
(12) Patent Application Publication
(10) Pub. No.: US 2019/0350209 A1
(43) Pub. Date: Nov. 21, 2019

(54) INSECT REPELLENT COMPOSITION FOR HUMANS, INDOOR AND OUTDOOR PURPOSE

(71) Applicant: Kalliope Dontas, Bethlehem, PA (US)

(72) Inventor: Kalliope Dontas, Bethlehem, PA (US)

(21) Appl. No.: 15/979,526

(22) Filed: May 15, 2018

(51) Int. Cl. A01N 65/08; A01N 25/02

(52) U.S. Cl. CPC A01N 65/08; A01N 25/02

(57) ABSTRACT

The invention relates to an insect repellent composition including natural ingredients like witch hazel, alcohol and essential oils in predetermined percentage appropriate for repelling outdoor and indoor insects. The said composition is safer to be sprayed or applied on humans and cause no side effects when sprayed around food items. The said composition only comprises natural ingredients and is devoid of any synthetic or poisonous substances.

### BACKGROUND OF INVENTION

### Field of Invention

The invention relates to an insect repellent composition including natural ingredients like essential oils in an astringent base (Witch Hazel) in predetermined percentage appropriate for repelling outdoor and indoor insects

### Description of Prior Art

There are widely available insect repellents in the market. Most of these contain an active ingredient DEET (N,N-Diethyl-meta-toluamide) which can provide protection against mosquitoes, ticks and many biting insects. DEET is often sold and used in lotions and sprays in concentrations as high as 100%. In 2002, Health Canada has already barred the sale of insect repellents for human use that contained more than 30% DEET. United States Environmental Protection Agency (EPA) in 1998 reported around 14 to 46 cases of potential DEET associated seizures including 4 deaths. In fact DEET has been also detected at low concentrations in water bodies as a result of recurrent production and rampant use. Thus, causing environmental damage.

It is rather the need of the hour to develop and formulate insect repellents devoid of any harmful chemical ingredients which may pose threat to human health as well as environment. The present invention addresses this issue in a manner that the chemical formulation of the present invention only consists of natural ingredients including various essential oils, witch hazel and alcohol in predetermined percentages to repel indoor as well as outdoor insects. At the same time, the present formulation offers myriad health benefits i.e. the present formulation is safer on surfaces around food, better smelling with no citronella, environment friendly, safer to spray on human face and hair and better fragrance than the contemporaries. The present insect repellent formulation is more effective than other conventional natural insect repellent formulations and repels a range of insects including but not limited to mosquitoes, bees, spiders, hornets and ticks.

Additionally prior publications like US20070224232A, WO02004060063A US20050244445, U.S. Pat. No. 6,749,861 and US20050112164A1 disclose more or less similar ingredients in the said formulations comprising cedarwood oil, lemon oil, grapefruit oil, tangerine oil, rosemary oil, clove oil, peppermint oil, geranium oil, etc. However, the present formulation includes newer ingredients that have not been disclosed in the prior arts which itself makes the formulation novel enough.

### SUMMARY OF INVENTION

The present invention features an effective insect repellent composition with natural ingredients including essential oils, alcohol and witch hazel in predetermined percentages. Witch hazel acts as the base in the formula and may be used in liquid, cream or gel form. About 10% of the formulation comprise essential oils.

The present invention is a safer formula around food surfaces, more effective and better smelling (with no citronella) than other formulas available in the market. The present formula repels a variety of insects including but not limited to spiders, hornets, ants, mosquitoes, bees, ticks etc. The formula is safer to spray on human skin or hair surface with no side effects. Additionally, the Witch Hazel (astringent) base in the formula keeps perspiration in control. Insects are particularly attracted to body heat, sweat and body odour, hence astringent keeps the perspiration in control and act as a natural facilitator for repelling variety of insects.

The present formula is available in a spray bottle. The formula may be sprayed in the air or on a variety of surfaces including human body and hair. The formula shall not be directly applied into human eyes or mouth and is not suitable for internal use. The formula may also be used in aroma diffusers but the overall efficacy of the repellent is much more enhanced when sprayed directly into the air, surfaces or applied on human body and hair.

The present formula is safer to use as compared to insect repellents with chemical insecticides. The formula has no side effects on environment and on humans. The formula comprises all-natural ingredients and essential oils in predetermined percentages. The formula is tested to repel vast range of flying and non-flying insects in wooded areas, outdoors, indoors, beaches etc.

The features and advantages of the present invention will become further apparent from the following detailed description of preferred embodiments, provided by way of example only.

### DETAILED DESCRIPTION OF PREFERRED EMBODIMENTS

The present invention comprises composition actively involved in repelling a variety of insects and may be used for both outdoor and indoor purposes. The primary composition consists of witch hazel, alcohol and essential oils in predetermined percentages. Witch hazel acts as a base in the formula and may be used in liquid, cream or gel form. About 10% of the entire formulation comprises essential oils. Essential oils are known to repel insects, however the selection of types of essential oils and their optimum percentages plays a major role in deciding about the overall insect repellent efficacy of the formulation. The present invention consists of a variety of essential oils in predetermined percentages, effective enough to repel variety of insects.

The formula may be sprayed in the air or on a variety of surfaces including human body and hair. The formula is not fit to be directly applied into human eyes or mouth and is not suitable for any internal use. Since it is the aroma of the present invention that repels a range of outdoor and indoor insects, this formula is fit enough to be used in aroma diffusers however the overall efficacy of the repellent is much pronounced when sprayed directly into the air, surfaces or applied on human body and hair. The formula is not nauseating unlike other citronella-based insect repellent formulas. One of the active compositions of the formula is Witch 1-Hazel (astringent) which is medically proven to reduce perspiration and eventually reduces the chances of bugs and insects being around the immediate vicinity. The formula is environmentally safe and fit for human use externally.

About 10% of the entire formulation comprises essential oils, these essential oils include Jasmine Absolute Oil, Lemon Oil, Rosemary Oil, Eucalyptus Oil, Sweet Basil Oil, Bergamot Oil, Peppermint Oil, Geranium Oil, Cardamom Oil, Ylang Ylang Oil, Chamomile Roman Oil, Cedarwood Oil, Spearmint Oil, Grape fruit Oil, Tangerine Oil, Myrtle Oil, Nutmeg Oil and Clove Oil. Sweet Basil oil is particularly used to keep mosquitoes away, the volatile oils in sweet basil oil are active against mosquitoes and repels them instantly. On the other hand, Geranium oil is a mild and effective oil against a variety of insects. It is tender on skin and safe for environment. Lemon oil and Peppermint oil are potent enough to repel mosquitoes, spiders and a variety of other insects. Cedarwood oil is another potent insect repellent and is toxic to fleas, ticks and mosquitoes. Cedarwood oil kills insects by dehydration, pheromone interference, neutralization of body fluids, inhibiting breathing and dissolving insect larvae. The natural effluvium of cedarwood oil repels insects. Tangerine oil also acts as insect repellent particularly mosquitoes. Grapefruit oil is also a non-toxic insect repellent which kills insects. Nootkatone is a natural organic compound found in grapefruit oil which kills variety of insects by blocking neurotransmitter octopamine receptors on insects nerve cells thereby causing their death. Myrtle Oil and nutmeg oil are natural insect repellents. Chamomile oil acts as an insecticide and is safer on human body as well as environment. Cardamom oil has anti-microbial properties and is a natural insect repellent. Ylang-Ylang Oil and Clove oil are natural insect repellents. However, the chief components of Ylang-Ylang essential oil are benzyl acetate, benzyl benzoate, linalool, caryophyllene, geranyl acetate, methyl benzoate, p-cresyl methyl ether, and other components known as sesquiterpenes, all of which contribute to aroma and medicinal properties. Thus, the combination of these essential oils in predetermined percentage contributes to overall insect repellent properties of the formulation.

The formula is available in plastic spray bottles, which may be used to disperse or spray the formula on variety of surfaces and air. The formula can also be used in aroma diffusers to disperse the aroma into the surrounding air. However, as discussed above, the efficacy of formula is minimized when used in aroma diffusers instead of direct application on the surfaces or into the air. The formula is better smelling than conventional natural insect repellent formulas due to a combination of various fragrant essential oils and no citronella base.

Witch Hazel is an alcoholic extract from shrub Hamamelis. This astringent has been used on the skin for centuries to relieve bruises, sprains, minor injuries and skin irritations, including insect bites. However, the effect of solo application lasts only few minutes. Hence, the present invention is made in such a manner to include the right mix of essential oils and other ingredients to give users an effective composition which can lasts up to several hours in terms of insect repellent efficacy. The table below gives a detailed account of percentages of all the ingredients in the present formulation.

TABLE 1

| Composition | Percentage by volume |
|---|---|
| Hamamelis virginiana | 77.4% |
| (Witch Hazel) | |
| Alcohol | 12.6% |
| Jasminum grandiflorum | 1.3% |
| (Jasmine Absolute Oil) | |
| Citrus limon | 1.3% |
| (Lemon Oil) | |
| Rosmarinus officinalis | 0.8% |
| (Rosemary Oil) | |
| Ocimum basilicum | 0.44% |
| (Sweet Basil Oil) | |
| Citrus bergamia | 0.44% |
| (Bergamot Oil) | |
| Mentha piperita | 0.44% |
| (Peppermint Oil) | |
| Pelargonium graveolens | 0.44% |
| (Grapefuit Oil) | |
| Elettaria cardamomum | 0.44% |
| (Cardamon Oil) | |
| Cananga odorata | 0.44% |
| (Ylang Ylang Oil) | |
| Anthemis nobilis | 0.44% |
| (Chamomile Roman Oil) | |
| Juniperus ashei | 0.44% |
| (Cedarwood Oil) | |
| Citrus paradise | 0.44% |
| (Grapefuit Oil) | |
| Citrus reticulata | 0.44% |
| (Tangerine Oil) | |
| Myrtus communis | 0.44% |
| (Myrtle Oil) | |
| Myristica fragrans | 0.44% |
| (Nutmeg Oil) | |
| Syzgium aromaticum | 0.44% |
| (Clove Oil) | |
| Eucalyptus globulus | 0.44% |
| (Eucalyptus Oil) | |
| Mentha spicate | 0.44% |
| (Spearmint Oil) | |

The terms “Formula” and “Formulation” and “Composition” have been used in the present specification interchangeably. Similarly terms “Ingredients” and “Composition” have been used in the specification interchangeably. While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

We claim:

1. An insect repellent composition comprising natural ingredients including witch hazel and an extensive combination of eighteen essential oils ready to be used on humans as well as outdoor and indoor insect repellent purposes.

2. An insect repellent composition of claim 1, wherein the composition can be externally used on human body surface including face and hair in order to repel a variety of indoor and outdoor insects including but not limited to mosquitoes, bees, spiders, hornets and ticks.

3. An insect repellent composition comprising witch hazel, alcohol and eighteen essential oils in predetermined quantities including Jasmine Absolute Oil, Lemon Oil, Rosemary Oil, Eucalyptus Oil, Sweet Basil Oil, Bergamot Oil, Peppermint Oil, Geranium Oil, Cardamom Oil, Ylang Ylang Oil, Chamomile Roman Oil, Cedarwood Oil, Spearmint Oil, Grape fruit Oil, Tangerine Oil, Myrtle Oil, Nutmeg Oil and Clove Oil respectively.

4. An insect repellent composition of claim 3, wherein Witch hazel acts as the base in the composition and may be used in liquid, cream or gel form.

5. An insect repellent composition of claim 4, wherein about 10% of the total formulation comprise eighteen essential oils.

6. An insect repellent composition according to claim 5, wherein witch hazel constitutes 77.4% by volume, lemon oil and Jasmine absolute oil constitutes 1.3% by volume, Rosemary oil constitutes 0.8% by volume, alcohol constitutes 12.6% by volume.

7. An insect repellent composition according to claim 6, wherein Sweet Basil Oil constitutes 0.44% by volume, Bergamot Oil constitutes 0.44% by volume, Peppermint Oil constitutes 0.44% by volume, Geranium Oil constitutes 0.44% by volume, Cardamom Oil constitutes 0.44% by volume, Ylang Ylang Oil constitutes 0.44% by volume, Chamomile Roman Oil constitutes 0.44% by volume, Cedarwood Oil constitutes 0.44% by volume, Spearmint Oil constitutes 0.44% by volume, Grape fruit Oil constitutes 0.44% by volume, Tangerine Oil constitutes 0.44% by volume, Myrtle Oil constitutes 0.44% by volume, Nutmeg Oil and Clove Oil constitutes 0.44% by volume respectively.

8. An insect repellent composition according to claim 1, wherein the composition itself offers myriad health benefits i.e. the present composition is safer on surfaces around food, better smelling with no citronella, environment friendly, safer to spray on human face and hair.

9. An insect repellent composition of claim 1, wherein the composition is available in plastic spray bottles, which may be used to disperse or spray the formula on variety of surfaces and air.

10. An insect repellent composition of claim 9, wherein the formula can also be used in aroma diffusers to disperse the aroma into the surrounding air.

11. An insect repellent composition according to claim 1, wherein the composition is better smelling than conventional natural insect repellent formulas due to a combination of eighteen fragrant essential oils and no citronella base.
